(19) United States
(12) Patent Application Publication
(10) Pub. No.: US 2014/0342300 A1
(43) Pub. Date: Nov. 20, 2014

(54) CLASS II/III CORRECTOR ACCOMODATING BITE PLATES

(71) Applicant: OrthoAccel Technologies Inc., Bellaire, TX (US)

(72) Inventor: Dwight SCHNAITTER, Bellaire, TX (US)

(73) Assignee: OrthoAccel Technologies Inc., Bellaire, TX (US)

(21) Appl. No.: 14/275,588

(22) Filed: May 12, 2014

Related U.S. Application Data
(60) Provisional application No. 61/824,798, filed on May 17, 2013.
(60) Provisional application No. 61/856,053, filed on Jul. 19, 2013.

(51) Int. Cl. A61C 7/00; A61C 7/36

(52) U.S. Cl. CPC A61C 7/008; A61C 7/36
USPC 433/24; 433/2

(57) ABSTRACT

Improved bite plates for use with orthodontic vibratory devices and devices offering other treatment modalities. The bite plates are specifically designed to be used with Class II and II correctors, such as the Herbst appliance. Such bite plates can be used with a variety of treatment modalities, including laser, IR, micropulse, vibration, and combinations thereof.

### PRIOR RELATED APPLICATIONS

This application claims priority to 61/824,798, filed May 17, 2013, and 61/856,053, filed Jul. 19, 2013, each incorporated by reference in its entirety for all purposes.

### FEDERALLY SPONSORED RESEARCH STATEMENT

Not applicable.

### FIELD OF THE INVENTION

This invention relates to bite plates that are specially shaped to allow them to be used with Herbst appliances and other class II or class III occlusion correctors, thus allowing vibration to applied in such cases to speed orthodontic remodeling.

### BACKGROUND OF THE INVENTION

A malocclusion is a misalignment of teeth or incorrect relation between the teeth of the two dental arches. The term was coined by Edward Angle—the father of modern orthodontics—as a derivative of occlusion, which refers to the way opposing teeth meet. Angle based his classifications of malocclusions on the relative position of the maxillary first molar. According to Angle, the mesiobuccal cusp of the upper first molar should align with the buccal groove of the mandibular first molar. The teeth should all fit on a line of occlusion, which is a smooth curve through the central fossae and cingulum of the upper canines, and through the buccal cusp and incisal edges of the mandible. Any variations therefrom is a malocclusion.

There are three classes of malocclusions, Class I, II, and III. Further, class II is subdivided into three subtypes:

Class I: Neutrocclusion The molar relationship of the occlusion is normal or as described for the maxillary first molar, but the other teeth have problems like spacing, crowding, over or under eruption, etc.

Class II: Distocclusion (retrognathism, overjet) In this situation, the upper molars are placed not in the mesiobuccal groove, but anteriorly to it. Usually the mesiobuccal cusp rests in between the first mandibular molars and second premolars. There are two subtypes:

Class II Division 1: The molar relationships are like that of Class II and the anterior teeth are protruded.

Class II Division 2: The molar relationships are class II but the central incisors are retroclined and the lateral incisors are seen overlapping the central incisors.

Class III: Mesiocclusion (prognathism, negative overjet) In this case, the upper molars are placed not in the mesiobuccal groove, but posteriorly to it. The mesiobuccal cusp of the maxillary first molar lies posteriorly to the mesiobuccal groove of the mandibular first molar. This malocclusion is usually seen when the lower front teeth are more prominent than the upper front teeth. In such cases, the patient very often has either a large mandible or a short maxillary bone.

Orthodontics, formerly orthodontia (from Greek orthos “straight or proper or perfect”; and odous “tooth”), is the first specialty of dentistry that is concerned with the study and treatment of malocclusion, which can be a result of tooth irregularity, disproportionate facial skeleton relationship, or both. Orthodontics treats malocclusion through the displacement of teeth via bony remodeling and control and modification of facial bone growth.

This process has been accomplished for hundreds if not thousands of years using static mechanical force to induce bone remodeling, thereby enabling teeth to move. In modern orthodontics, braces consisting of an archwire interfaces with brackets that are affixed to each tooth. As the teeth respond to the pressure applied via the archwire by shifting their positions, the wires are again tightened to apply additional pressure. This widely accepted approach to treating malocclusion takes about twenty-four months on average to complete, and cannot be rushed by applying more force because of the risk of root resorption.

A Herbst® appliance is a device invented in 1904 by Doctor Emil Herbst and used to correct a class II malocclusion (recessed lower jaw or overbite). The mandible is held in a protrusive (forward) position by means of a tube that is fixed to a pivot located on a band or crown on the maxillary first molars. A rod fits into this tube and is attached to another pivot located on a band or crown on the mandibular first or second premolars. The patient can open and close their jaws, but the rod and tube mechanism prevents the mandible from moving back into its prior position. By holding it in this advanced position, the growth of an underdeveloped mandible is enhanced, helping to improve facial contours and treat a Class II molar relationship. There are analogous devices to correct class III malocclusions, where the lower jaw protrudes, rather than being recessed.

Treatment with braces with or without a Herbst or other class II or III corrector is complicated by the fact that it is uncomfortable and/or painful for patients, and the orthodontic appliances are perceived as unaesthetic, all of which creates considerable resistance to use. Additionally, the 24-month average treatment time is very long, and further reduces usage. In fact, some estimates provide that less than half of the patients who could benefit from such treatment elect to pursue orthodontics.

Kesling introduced the tooth-positioning appliance in 1945 as a method of refining the final stage of orthodontic finishing after removal of the braces (debanding). The positioner was a one-piece pliable rubber appliance fabricated on the idealized wax set-ups for patients whose basic treatment was complete. Kesling also predicted that certain major tooth movements could also be accomplished with a series of positioners fabricated from sequential tooth movements on the set-up as the treatment progressed. However, this idea did not become practical until the advent of 3D scanning and computer modeling in 1997, when the Invisalign® system was introduced by Align Technologies®. Although clear aligners present a significant technological advance in materials, the treatment principle is the same as the last two thousand years—applying a static force to slowly move teeth via boney remodeling.

In addition to static forces, cyclic forces can also be used for orthodontic remodeling. Kopher and Mao assessed cyclic forces of 5N peak magnitude at 1 Hz in rabbits, while Peptan and Mao assessed cyclic forces of 1N at 8 Hz in rabbits, and Vij and Mao assessed cyclic forces of 300 mN at 4 Hz in rats. In aggregate, the data from these three studies indicated that cyclic forces between 1 Hz and 8 Hz, with forces ranging from 0.3N to 5N, increased the speed of boney remodeling.

The early studies by Dr. Mao provided a basis for both possible efficacy and likely safety for using vibration in humans to assist orthodontic tooth movement, but the animal studies needed to be repeatable in humans, and the devices used by Dr. Mao and the others were completely unsuitable for human clinical work.

OrthoAccel Technologies Inc., invented and tested the first commercially successful dental vibrating device, as described in US20080227046 and related cases, designed to apply cyclic forces to the dentition for accelerated bone remodeling purposes. Both intra-oral and extraoral embodiments are described in US20080227046.

The bite plate was specially designed to contact occlusal as well as lingual and/or facial surfaces of the dentition, and thus was more effective than any prior art devices in conveying vibrational forces to the teeth, transmitting vibration in two axes. Further, the device was tested in clinical trials and was shown to speed orthodontic remodeling as much as 50%, and is truly a breakthrough in orthodontic technology (Kau 2010).

Finally, the device is slim, capable of hands free operation, lacks the bulky head-gear of prior art devices, and has optimized force and frequency for orthodontic remodeling. Thus, its comfort level and compliance was also found to be high, with patients reporting that they liked the device, especially after the motor was redesigned to be quieter and smoother, as described in US20100055634 et seq. In fact, this device has been marketed as AcceleDentTM in the United States and several other countries and has achieved remarkable commercial success since its recent introduction. AcceleDentTM represents the first successful clinical approach to accelerate orthodontic tooth movement by modulating bone biology in a non-invasive and non-pharmacological manner.

Although the AcceleDent has been clinically shown to reduce treatment times as much as half, the bite plate was designed for the average Caucasian patient, and did not easily accommodate the Herbst appliances or other class II or III correctors, which provide buccal bulk from the premolars posteriorly. Therefore, what is needed in the art is a redesigned bite plate that accommodates the bulk of such class II or III correctors.

### SUMMARY OF THE INVENTION

The prior bite plate designs of US20080227046 and US20100055634 consisted of a U-shaped bite plate that contacted the occlusal surfaces of the dentition. A vertical edge on the facial side of the U-shaped plate, and a partial vertical edge on the lingual side was also included. The occlusal contact and facial/lingual contact allow the vibration to be imparted in an up-and-down direction, as well as front-to-back direction. The vertical edges and horizontal base, thus allows the vibration to be transferred to the teeth in two axes, and are much preferred over a simple flat bite plate.

The commercial models have a facial/buccal edge that contacts the dentition up to the premolars, although molar contact was omitted since many children do not yet have molars and even in adults there is limited distal space. In addition, there is a vertical edge contacting the incisal or incisal and cuspid teeth on the lingual side. This lingual edge also serves to keep the bite plate correctly positioned over the teeth. Although successful and accommodating many patients, this design does not easily accommodate class II or III correctors, which provides considerable buccal bulk.

The disclosure is thus directed to a redesigned bite plate that accommodates the Herbst appliance and other class II or III correctors. The bite plate is similar to the designs described above, but the buccal edge is eliminated from the interproximal contact of the cuspid and first premolar distal, thus allowing the Class II or III appliance to use this space.

In some embodiments, the lack can be compensated by a lingual edge, but in other embodiments it is not. The lingual edge can thus be eliminated, or contact just incisors, incisors and cupids, or incisors, cuspids and one or more premolars. Preferably, the lingual edge contacts at least lateral and central incisors, and can include cuspid, or cuspid and premolar contact, although the height of the edge can be reduced in this area to accommodate varying dentition and orthodontic appliances.

The U-shaped base of the bite plate can also be shortened, so that the distal most tooth or teeth are free, leaving this distal occlusal space free for fixed appliances. The base can terminate at the beginning of the molars, or after the first molar, depending on which fixed appliance the device is intended to be used with.

The height of the rims can also be shortened, leaving room for e.g., temporary anchorage devices (TADs), palatial expanders, and the like. Therefore, while the prior model rims were 6-7 mm in height, the rim height can be reduced to 1-3 mm in height, and further can taper from 6.5 mm mesially (e.g., at the incisors) to 1-3 mm at the cuspid. In one embodiment, the entire lower rim is shortened to 2-3 mm, and tapers to zero or near zero at the cuspid.

In some embodiments, the bite plate has an inner core that is made of e.g., metal, ceramic or a rigid plastic, such as acrylate or polycarbonate. The inner core is sufficiently stiff so as to transmit vibration to the mouthpiece and thence to the teeth. The inner core can be flat (except for the connector), or can be shaped to have the vertical edges, as desired.

The inner core is connected to or is integral with a connector at the median line, and projecting extra-orally, which serves to operably connect the bite plate to an extraoral driver. The connector can be of any suitable shape, but preferably provides a reversible snap fit to the extraoral driver. The connector is preferably integral with the inner core, but can be a separate component attached thereto, or can have separate components added to an integral connector, e.g., a spring.

The inner core is covered with a hermetically sealed polymeric coating or cover, wherein the outer surface thereof is shaped to contact all occlusal surfaces and facial central and lateral incisor surfaces, cuspid surfaces, but not premolar or molar surfaces. The bite plate can contact some or all of the facial cuspid surfaces, depending on the prominently used class II/III contact points, but generally is sized to omit first premolar contact on the average sized user. Preferably the coating is moderately flexible, thus protecting the teeth from abrasions that would occur with a very rigid material.

Where no inner core is included in the dental plate, the entirety of the bite plate is molded to have the desired shape, including the vertical edges or rims.

If desired, additional coatings can be applied thereto, e.g., a soft, tasteless coating can be provided over an otherwise suitable material that has unpleasant taste. Alternatively, flavored coatings can be used, providing e.g., mint or lemon flavors. Medical grade silicone is known to provide a material with the desired characteristics, but additional polymers are known, and some are described herein.

The bite plate is combined with any treatment modality, including vibration, laser light, IR light, electromagnetic pulses, electrical micropulses, heat, and the like, but preferred embodiments include the extraoral vibrators described in US20080227046, US20100055634 and US20120322018. The bite plate is preferably used with the existing extraoral vibrational device, which is already cleared for marketing in the US and several other places and already has proven efficacy. Thus, the class II or III corrector accommodating bite plate ideally has the same connector, and can be used with the existing driver.

In addition, the same principles can be applied to a completely intra-oral device, wherein the vibratory source or other treatment modality, power source and wiring are mounted directly on the bite plate.

Preferred extraoral vibratory sources are described in the OrthoAccel patents cited herein, and in particular include a device vibrates at a single frequency between 20-40 Hz, and at a single force between 0.1-1 Newtons (1N=1 kg m/s²). More preferred, the device vibrates at a single frequency between 20-40 Hz with a variation of less than 2 Hz, and at a single force between 0.1-0.5 Newtons with a variation of less than 0.05 Newtons. Even more preferred the device vibrates at 30 Hz with a variation of less than 2 Hz, and at 0.2 or 0.25 Newtons with a variation of less than 0.03 Newtons. Variation should be measured under conditions of use, e.g., by a patient for 20 minutes.

The preferred polymer for the bite plate has no taste or toxicity, does not leach components, and is preferably tested for same before use according to known tests. Where a polymer does leach, it can be coated with a sealant, but a non-leaching polymer is preferred since sealants have a limited lifespan in an oral environment.

The most preferred materials are medical grade or FDA cleared for oral use and are tasteless, non-toxic, and biocompatible. Suitable resins may include an epoxy, a cyanoacrylate, an acrylate, a urethane, an acrylate and urethane mixture, a urethane oligomer/(meth) acrylate monomer blend resin, a silicone, a silicone copolymer, or a copolymer of hydrogen siloxanes and unsaturated compounds. Medical grade silicone is particularly preferred.

Alternatively, the resin may comprise copolymers of hydrogen siloxanes and unsaturated compounds. These may be used as adhesion promoters to build a chemical link between the resin and the shapeable core. An example of such an adhesive is described in DE19934117 and incorporated by reference herein for all purposes. Other resins are described in e.g., U.S. Pat. No. 5,856,373; US20110200973; U.S. Pat. No. 5,017,626; U.S. Pat. No. 4,459,193; U.S. Pat. No. 4,411,625; U.S. Pat. No. 4,771,084; US20050049326.

The current polymers are clear, but colored pellets can be added to the polymer in the molten form, thus making colored bite plates, which can appeal to younger patients. If desired, the outer surfaces can also be imprinted with designs, and, if needed for longevity, can be coated with a sealant.

By “U-shaped” what is meant herein is that the bite plates follow the curvature of the dentition, e.g., the biting surfaces of the teeth are in a substantially U-shaped curvature.

When we refer to contacting “the teeth” or “the dentition” or similar phrase herein, what is meant is the teeth of both arches, unless the maxillary teeth or mandibular teeth are specifically referred to, or teeth are named separately. Nevertheless, the bite plate need not contact every single tooth, since by definition malocclusions may result in one or more teeth being considerably out of alignment.

By “treatment modality” what is meant is a mode of action that causes an orthodontic benefit.

By “treatment modality source,” what is meant is a device or component of a device that provides the treatment modality. For example, vibration is an orthodontic treatment modality and a vibratory source provides vibration. A vibratory source could also be called a vibrator. Another treatment modality is infrared light, and an LED could be an exemplary light source.

An “extraoral driver” is the extraoral component that provides the treatment modality, and in preferred embodiments is a housing enclosing a treatment modality source such as a vibrator or laser, a processor, a battery or other power source, and the wiring needed to operatively couple or operate same, and wherein the housing has a socket for receiving the connector of the bite plate (or vice versa). The housing would preferably be at least water resistant or even waterproof. Preferably, the housing also contains a processor to control the treatment modality source, and preferably it also records and transmits usage compliance data.

By “recording and transmitting” data what is meant is that the device records or captures data, such as date, time and duration of each use, and can then transmit that data to a user or other device, such as a smartphone, stand alone PC or the internet. USB ports, wireless data ports such as the Bluetooth, and the like, can provide this transmission functionality, and any processor can capture the data. Research has shown that the ability to monitor compliance increases compliance, especially in younger and teen patients.

By “usage compliance data” what is meant is data relating to how often and how long a user actually employs the device. Thus, usage compliance data can include the date, time, length of use, and the like.

By “rigid” herein in reference to the inner core, what is meant is that the core is stiff enough to transfer at least 0.1-0.5 N, preferably 0.02 or 0.025 N of vibration to the teeth.

By “daily” what is meant is at least 67% compliance in daily use. Although perfect compliance would obviously be preferred, significantly increased speed of orthodontic remodelling (greater than 50%) was seen at only 67% compliance in the Kau study.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated. When used in the context of part dimensions, the term includes those tolerances that are acceptable and still allow the parts to operably connect. Where a part material is flexible, the tolerance may be slightly higher, but a rigid part made of metal will typically have smaller tolerances.

The use of the term “or” in the claims is used to mean “and/or” unless explicitly indicated to refer to alternatives only or if the alternatives are mutually exclusive.

The terms “comprise”, “have”, and “include” (and their variants) are open-ended linking verbs and allow the addition of other elements when used in a claim.

The phrase “consisting of” is closed, and excludes all additional elements.

The phrase “consisting essentially of” excludes additional material elements, but allows the inclusions of non-material elements that do not substantially change the nature of the invention. Thus, the term “consisting essentially of” does not exclude immaterial elements, such as packaging, instructions for use, and the like. Bulky head-gear, used to hold prior art devices in place and/or provide additional orthodontic remodeling forces, is considered material, however.

### BRIEF DESCRIPTION OF THE DRAWINGS

FIG. 1A-B shows nomenclature for the teeth. Standard dental terminology is used herein.

FIG. 2A-B shows two exemplary Herbst appliances, wherein the example in FIG. 2B is shown on a model that also has braces.

FIG. 3A shows top view of a bite plate, and FIG. 3B shows the same plate in perspective.

FIG. 4A shows top view of a bite plate, and FIG. 4B shows the same plate in perspective, and FIG. 4C shows the bite plate being used in combination with a Herbst device.

FIGS. 5A-C compares the current (FIG. 5A) and prior art (FIG. 5B) bite plates. FIG. 5C shows the two bite plates side by side, wherein the shorter base and shorter rims of the current bite plate are more clearly visible on the upper bite plate.

FIG. 6A-6E shows the preferred connector for the bite plate with its dimensions.

### DETAILED DESCRIPTION OF THE INVENTION

The disclosure describes a class II or III corrector accommodating bite plate, preferably having the characteristics of the special prior art bite plates described in US20080227046, US20080227047, US20100055634, US20120332018, 61/624,242, 61/615,480 and 61/673,236 and intended to be used with intra-oral or extraoral vibratory or other treatment modality sources, as described in the preceding applications for patent, each incorporated by reference in its entirety.

In yet other embodiments, the bite plate omits the connector and has fitted therein one or more e.g., coin vibrators or other tiny vibratory source(s), which are operably coupled to one or more coin battery(s) or charged capacitor(s), which are operably coupled to an optional processor for controlling the device and monitoring usage compliance. Thus, the entire device is intra-oral.

In yet other embodiments, the device uses other treatment modalities in place of or in addition to pulsed or cyclic forces (aka vibration). Thus, the device can be fitted with IR light source, EM field source, microelectronic pulse source, and the like. However, in preferred modalities, the device includes a vibrational source, since vibration has already been proven in clinical trials to reduce remodeling time by 50%.

In use, a patient wearing a class II or II corrector, usually with additional fixed appliances, such as braces, aligners, tads, palatial expanders, and the like, bites on the bite plate to hold it firmly during use. No headgear is needed, and the orthodontic forces are provided by the fixed appliances. Vibration is applied for about 20 minutes, preferably daily, over the course of treatment. A double blind clinical trial (see clinicaltrials.gov) has shown that this method will reduce the time needed by 50% (e.g., one year treatment time instead of the typical two).

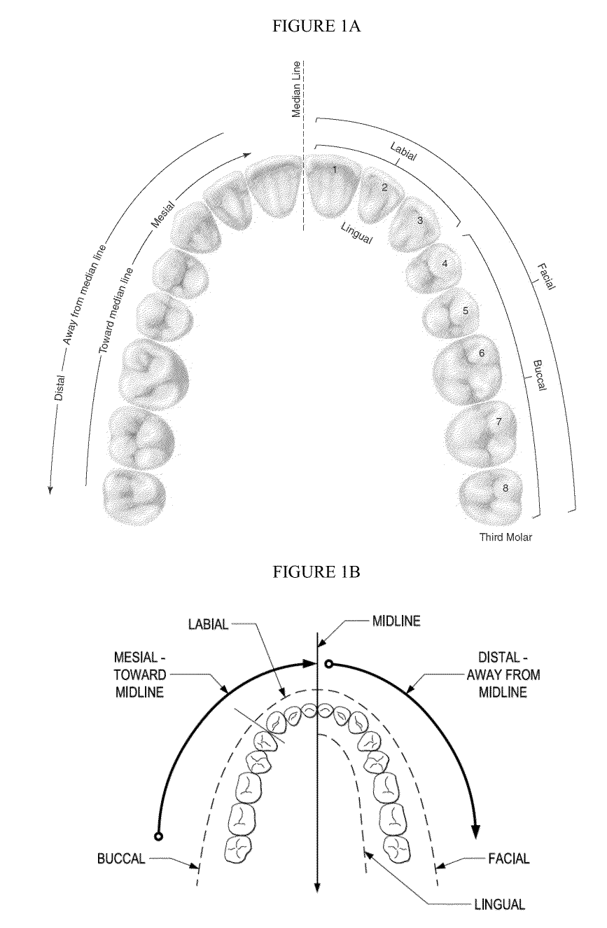

FIG. 1A-B shows standard dental nomenclature, which is employed herein. The central and lateral incisors and the cuspids are also known as “anterior” teeth, while the premolars and molars are “posterior.”

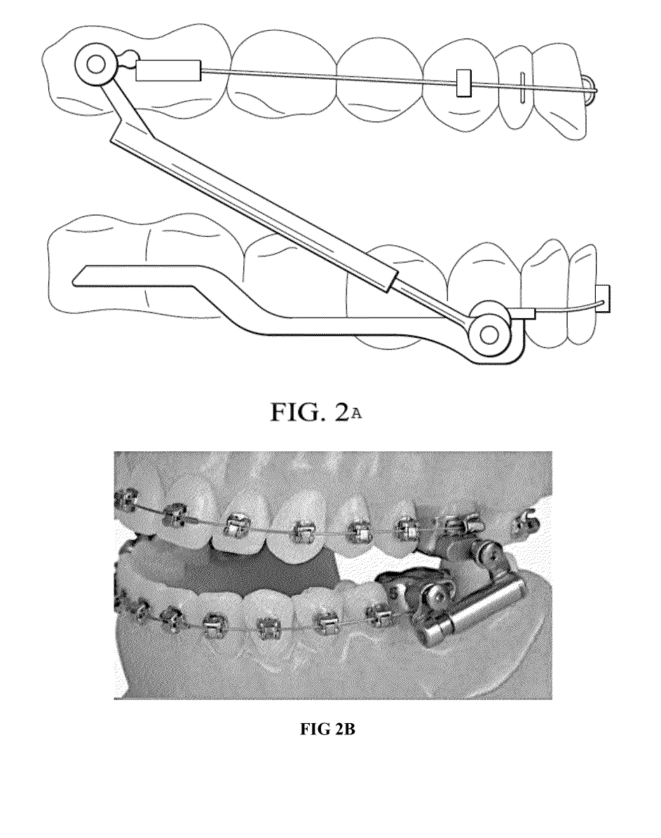

FIG. 2A-B shows typical Herbst appliances, which provides buccal bulk from at least the premolars back towards the molars. In FIG. 2B, the use of a Herbst with braces is seen on the dental model. There are many variations on class II/III correctors, all of which are included herein.

As can be seen, in each of the embodiments, bite plate is generally U-shaped, following the curve of the dentition. Preferably, the device is manufactured and sold in a Euro arch form, thus fitting the majority of North American and European patients, but a wider arch can also be made, so as to fit a majority of Asian patients, or the even wider Damon arch can be used.

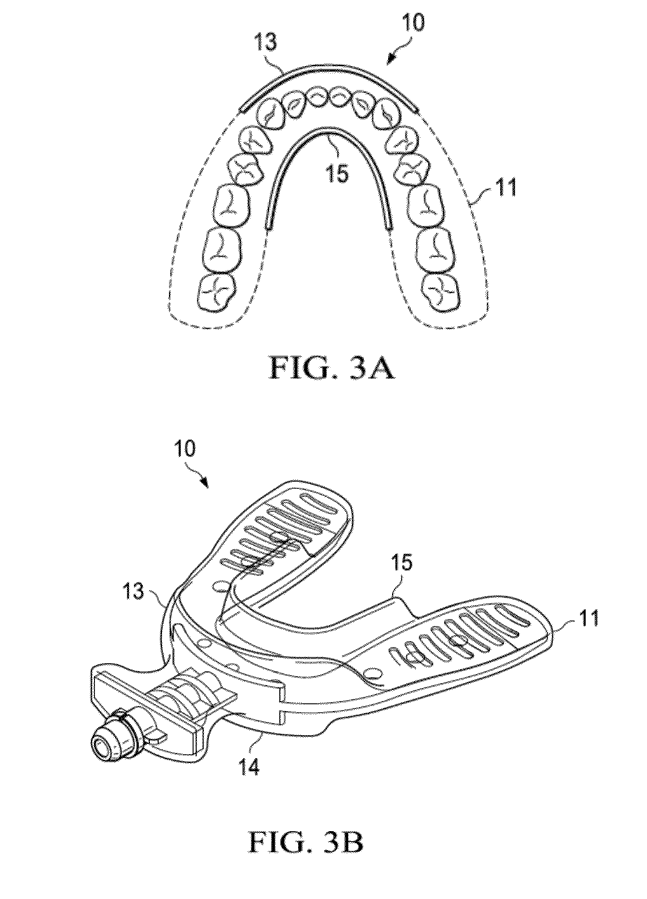

FIG. 3A-B shows one embodiment of the bite plate. In FIG. 3A, the bite plate 10 is shown from the top, the U-shaped base 11 shown in dotted outline, with the facial rim or vertical edge 13 contacting facial surface of only the incisors and cuspids. In contrast, no edge is present distal to the cuspid, e.g., the premolars and molars, thus leaving space to class II or III correctors. Also shown is lingual rim 15, in this case contacting all incisors, cuspids, and first and second premolar. Further, in perspective view of FIG. 3B, it can be seen that the height of the rim decreases once past the anterior teeth. In this instance, the base 11 is shown long enough to contact all molars, but of course in younger patients without a full set of 32 teeth, this base should be shorter. Further, with certain correctors, it may be desirable to shorten the base, leaving one or more molars free for fixed appliances on the occlusal surfaces. The lower facial or vertical edge 14 can also be seen in FIG. 3B.

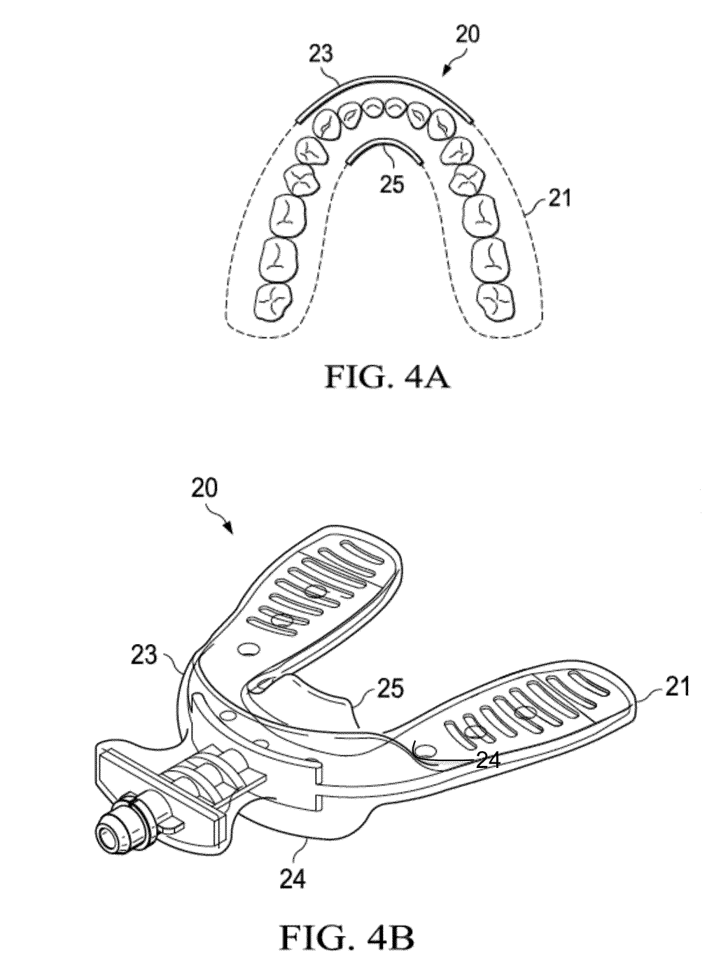

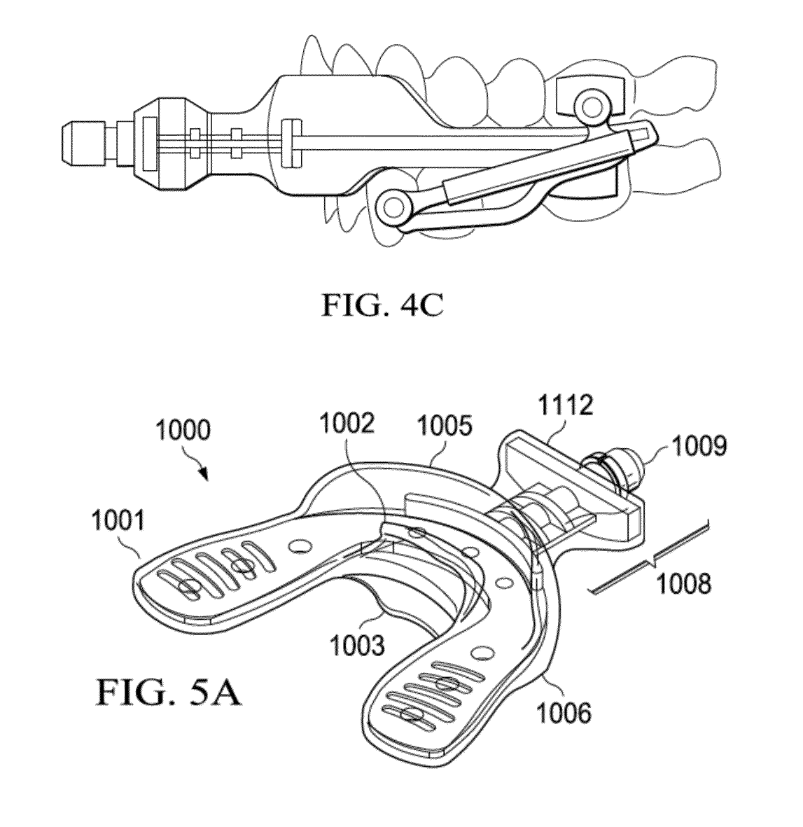

FIG. 4A-B show another embodiment of the bite plate. In FIG. 4A, the bite plate 20 is shown from the top, the U-shaped base 21 shown in dotted outline, with the upper facial rim or vertical edge 23 and lower facial rim 24 contacting facial surface of only the incisors and cuspids. In contrast, no edge is present distal to the cuspid, e.g., the premolars and molars, thus leaving space to class II or III correctors. Also shown is the lingual rim 25, in this case contacting only incisors and cuspids. FIG. 4B shows the same bite plate in perspective. FIG. 4C additionally shows the bite plate being use in combination with a Herbst device. As shown in the figure, the shorter upper and lower facial rims allow the user to concurrently use both the Herbst device and the bite plate without crowding.

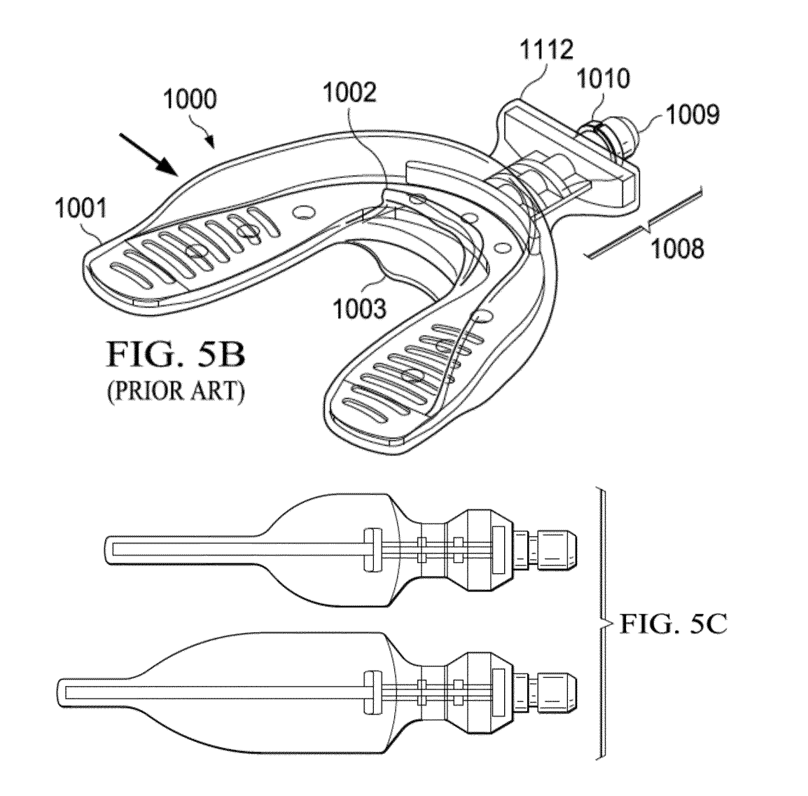

FIG. 5A compares the current bite plate with the prior art bite plate of FIG. 5B. Each are shown in perspective with an arrow indicating where the facial edge ends (at the cuspid in FIG. 5A, but reaching much further to e.g., the molars in FIG. 5B). FIG. 5C shows the two bites plates side by side, clearly illustrating the shorter base and shorter rims of the current invention on the top plate.

In more detail, FIG. 5A-B show a bite plate 1000, having generally U-shaped base 1001 that contacts occlusal surfaces of the teeth, the base having front and back edges, one or both edges having a rim to contact the facial and lingual surfaces of teeth and/or gums. Thus, upper lingual rim 1002, lower lingual rim 1003, upper facial rim 1005 and lower facial rim 1006 (also shown in FIG. 4B) are shown. In this instance, in FIG. 5A, the lingual rims 1003 contact only the incisors and/or canines, but not the molars. However, the lingual rims can be varied in length to contact all, or a portion, of the lingual teeth surfaces. As described throughout, the facial rim is shortened so that it does not reach beyond the average cuspid position.

Also shown in FIG. 5A-B is the stem 1008, which is the portion of the bite plate 1000 that mates with a corresponding socket in the extra-oral housing (not shown here). In more detail, a cylindrical shaft 1009 is shown, having a groove into which a jump ring 1010 fits, and mates with a corresponding depression in the socket. Optional flare 1112 is also shown, and is configured to provide an appropriate surface so that the user can push the stem into the socket.

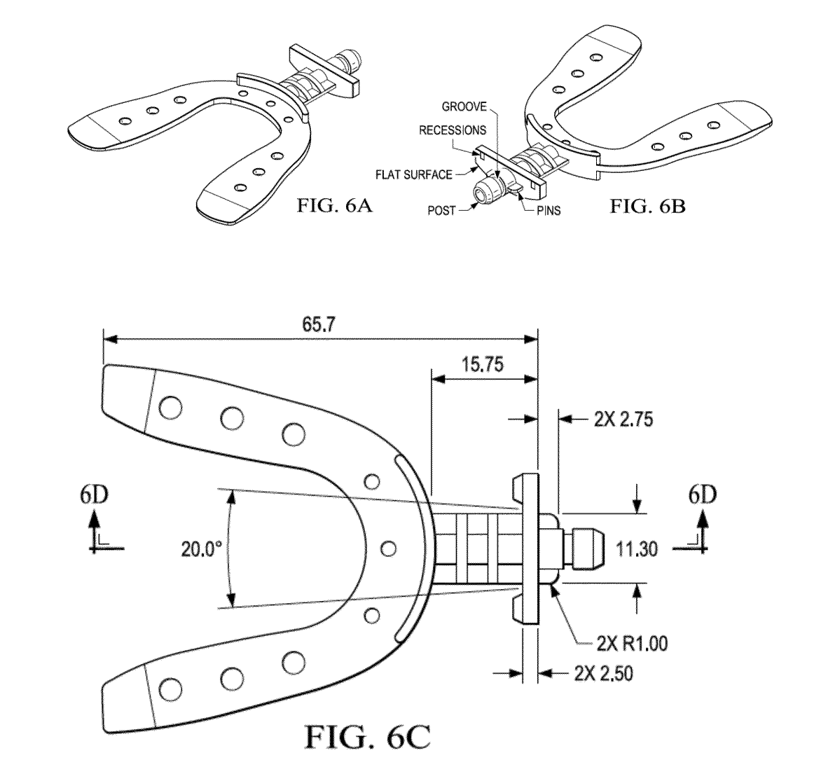

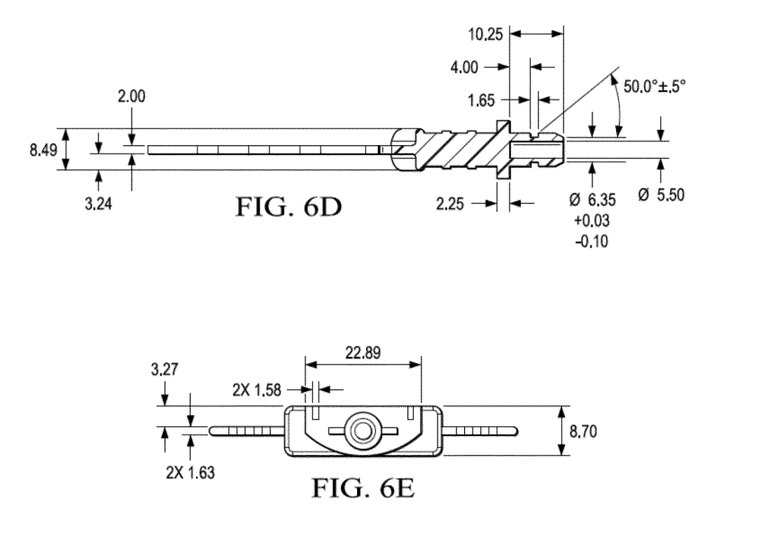

FIG. 6A-E shows the core of the bite plate, typically made from a resin, metal or ceramic having a harder durometer than the outer surface, and providing sufficient rigidity to the stem 1008 so as to allow it to lockingly fit into the socket. This same inner core can be used for the plate of FIG. 5A or FIG. 5B, and fits on the existing extra-oral driver (not shown). FIG. 6A shows the core from one angle, and 6B from another angle. FIG. 6C-E shows the various dimensions of the components of the core and connector.

In FIG. 6B, the cylindrical shaft has a groove, into which jump ring or circular coil spring fits. The connector can also having locking pins and/or orientation pins to prevent the bite plate from being inserted upside down. Generally plastics of at least 40 Shore D are used for the core, but metals or ceramics could also be used. A coating is provided over this core, and provides the final shape of the bite plate, as shown in FIG. 5A or FIG. 5B. Such coating should be a biocompatible soft polymer of 40-70 Shore A, and particularly preferred is a medical grade, clear silicone.

In addition, it is preferred that the bite plate have a connector that is completely compatible with existing drivers, being of the same size and proportions. Using similar connectors allows the bite plates to be interchangeable, and also allows any bite plate inventory to be used even when the driver unit model is updated. Thus, these sizes are valuable for interchangeability of parts. The minimum for interchangeable parts based on the current models requires the cylindrical post to be about 10.25 mm in length and about 6.35 mm in diameter mm with a groove about 4 mm from the attached end of the post.

The connector in FIGS. 6A-E has a flared base (flare not shown herein because made from the over-coating material, but can be seen in FIG. 3) with a flat surface opposite the bite plate, from which protrudes a centrally positioned cylindrical post that is 6-7 (6.35 +0.03, −0.1 tolerances indicated) mm in diameter, 10-11 (10.25) mm in length, and having a groove circumventing the post about half way (4 mm from flat surface, with width of 1.65 mm).

The bottom of the post also has a pair of ˜1.4×3 mm pins (optional) projecting 180° from each other (in the same plane as the occlusal contacting base of the bite plate). These pins have a total spread of 11.30 mm at the topmost edge, but flare 10° on each side (20° total) to reach the flat surface of the base. The pins are 1.63 mm thick, and 2.75 mm high.

The base of the connector also preferably has a pair of recessions ˜1.5 mm wide×˜3 mm long×∥2 mm deep (1.58×3.27×2.5 mm) on the flat surface thereof for engaging clips from the driver, the recessions being about 16-17 mm apart (22.89 mm in spread), and positioned right below the pins. The recessions can be omitted however, if the base is either not flared or is otherwise smaller, such that the remaining post and pins still fit, leaving the engaging clips on the driver free. These dimensions are approximate, and exact dimensions are provided on FIGS. 6C-E.

The invention includes one or more of the following embodiments, in any combination thereof:

An orthodontic remodeling device comprising an extra-oral driver a bite plate, said bite plate
comprising:
an inner core in an U-shape to contact occlusal surfaces of a patient's incisors, cuspids and premolars;
said inner core covered with a flexible biocompatible polymer;
said flexible biocompatible polymer shaped to have an outside edge having upper and lower rims to
contact upper and lower facial surfaces of said patient's incisors, but not premolars or molars;
wherein the bite plate has a connector at a median line thereon for reversibly coupling to said driver.
An intra-oral orthodontic remodeling device comprising a vibrating bite plate, said bite plate comprising:
an inner core that is substantially U-shaped to contact occlusal surfaces of a patient's incisors, cuspids
and premolars;
a biocompatible covering on said inner core;
said biocompatible covering having an outside edge having upper and lower rims to contact an upper
and lower facial surfaces of said patient's incisors, but not premolars or molars;
wherein said inner core has a vibrator on a surface thereon operably coupled to a battery or charge
capacitor and wherein said vibrator and battery or charged capacitor are hermetically sealed inside
said biocompatible covering.
An improved orthodontic remodeling device having an extra-oral housing containing a power source
operably coupled to a 20-40 Hertz, 0.1-0.5 Newton vibrator operably coupled to a processor that
controls said vibrator and records and transmits usage compliance data; said extra-oral housing
reversibly connected to a bite plate, the improvement comprising a bite plate that contacts occlusal
surfaces of the incisors, cupids and premolars and contacts the facial surfaces of upper and lower
incisors, but not the premolars or molars.
The bite plate has upper and lower rims to contact upper and lower lingual surfaces of said patient's
incisors and cuspids.
The bite plate has upper and lower rims to contact upper and lower lingual surfaces of said patient's
incisors, cuspids and first premolar.
The bite plate has upper and lower rims to contact upper and lower lingual surfaces of said patient's
incisors, cuspids, and premolars.
The bite plate has upper and lower rims to contact upper and lower lingual surfaces of said patient's
incisors, cuspids, premolars and one or more molars.
The biocompatible polymer comprises medical grade silicone and said inner core comprises
polycarbonate.
The facial rims contact no part of the cuspids, or a portion of the cuspids or all of the cuspids.
The lower facial rims contact no part of the cuspids, or a portion of the cuspids, while the upper facial
rim covers more of the cuspids.
The facial rims are modified to accommodate specific types and sizes of class II/III correctors.
The driver includes a water resistant housing containing a vibrator operably coupled to an power
source operably coupled to an processor for controlling device usage and for recording and
transmitting usage compliance data.
The vibrator vibrates at a selected frequency from 20 to 40 Hz and at a selected force from 0.1 to 0.5
Newtons.
The vibrator vibrates at 30 Hz and 0.2 Newtons.
The driver uses PEMF, electric micropulses, infrared, or other treatment modalities.
The connector being a cylindrical post having a base end near said bite plate, said cylindrical post
being 5.5 mm diameter and about 10.25 mm in length and having a groove circumnavigating said
cylindrical post at 4 mm from said base end.
The biocompatible covering comprises a medical grade silicone and said inner core comprises
polycarbonate.
A faster method of orthodontic remodeling, said method comprising a patient wearing a class II or III
corrector biting the bite plate of claim 1, and vibrating said device for about 20 minutes daily, wherein
said method speeds orthodontic remodeling by 50% as compared to a comparable patient not using
said device.
A faster method of orthodontic remodeling, said method comprising a patient wearing a class II or III
corrector biting the bite plate of claim 12, and vibrating said device for about 20 minutes daily, wherein
said method speeds orthodontic remodeling by 50% as compared to a comparable patient not using
said device.
A faster method of orthodontic remodeling, said method comprising a patient wearing a class II or III
corrector biting the bite plate of claim 17, and vibrating said device for about 20 minutes daily, wherein
said method speeds orthodontic remodeling by 50% as compared to a patient using only said class II
or III corrector.

Each of the following are incorporated by reference herein in their entireties for all purposes.

US20080227046, US20080227047, US20100055634, US20120332018, 61/624,242 (Apr. 13, 2012), Ser. No. 13/850,151 (Mar. 25, 2013) and 61/673,236 (Jul. 18, 2012).

U.S. Pat. No. 6,648,639, U.S. Pat. No. 6,832,912, U.S. Pat. No. 7,029,276

U.S. Pat. No. 5,967,784

Kau, et al., The clinical evaluation of a novel cyclical force generating device in orthodontics, Orthodontic Practice 1(1) (2010).

While the invention is described above in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1) An orthodontic remodeling device comprising an extra-oral driver and a bite plate, said bite plate comprising:
i) an inner core in an U-shape to contact occlusal surfaces of a patient's incisors, cuspids and premolars;
ii) said inner core covered with a flexible biocompatible polymer;
iii) said flexible biocompatible polymer shaped to have an outside edge having upper and lower rims to contact upper and lower facial surfaces of said patient's incisors, but not premolars or molars; and,
iv) wherein the bite plate has a connector at a median line thereon for reversibly coupling to said driver.

2) The orthodontic remodeling device of claim 1, wherein said bite plate has upper and lower rims to contact upper and lower lingual surfaces of said patient's incisors and cuspids.

3) The orthodontic remodeling device of claim 1, wherein said bite plate has upper and lower rims to contact upper and lower lingual surfaces of said patient's incisors, cuspids and first premolar.

4) The orthodontic remodeling device of claim 1, wherein said bite plate has upper and lower rims to contact upper and lower lingual surfaces of said patient's incisors, cuspids, and premolars.

5) The orthodontic remodeling device of claim 1, wherein said bite plate has upper and lower rims to contact upper and lower lingual surfaces of said patient's incisors, cuspids, premolars and one or more molars.

6) The orthodontic remodeling device of claim 1, wherein said biocompatible polymer comprises medical grade silicone and said inner core comprises polycarbonate.

7) The orthodontic remodeling device of claim 1, wherein said driver includes a water resistant housing containing a vibrator operably coupled to a power source operably coupled to a processor for controlling device usage and for recording and transmitting usage compliance data.

8) The orthodontic remodeling device of claim 7, wherein said vibrator vibrates at a selected frequency from 20 to 40 Hz and at a selected force from 0.1 to 0.5 Newtons.

9) The orthodontic remodeling device of claim 7, wherein said vibrator vibrates at 30 Hz and 0.2 Newtons.

10) The orthodontic remodeling device of claim 1, said connector being a cylindrical post having a base end near said bite plate, said cylindrical post being 5.5 mm diameter and about 10.25 mm in length and having a groove circumnavigating said cylindrical post at 4 mm from said base end.

11) The orthodontic remodeling device of claim 10, wherein said biocompatible covering comprises a medical grade silicone and said inner core comprises polycarbonate.

12) An intra-oral orthodontic remodeling device comprising a vibrating bite plate, said bite plate comprising:
i) an inner core that is substantially U-shaped to contact occlusal surfaces of a patient's incisors, cuspids and premolars;
ii) a biocompatible covering on said inner core;
iii) said biocompatible covering having an outside edge having upper and lower rims to contact an upper and lower facial surfaces of said patient's incisors, but not premolars or molars; and,
iv) wherein said inner core has a vibrator on a surface thereon operably coupled to a battery or charge capacitor and wherein said vibrator and battery or charged capacitor are hermetically sealed inside said biocompatible covering.

13) The intra-oral orthodontic remodeling device of claim 12, wherein said bite plate has upper and lower rims to contact upper and lower lingual surfaces of said patient's incisors and cuspids.

14) The intra-oral orthodontic remodeling device of claim 12, wherein said bite plate has upper and lower rims to contact upper and lower lingual surfaces of said patient's incisors, cuspids and first premolar.

15) The intra-oral orthodontic remodeling device of claim 12, wherein said vibrator vibrates at a selected frequency from 20 to 40 Hz and at a selected force from 0.1 to 0.5 Newtons.

16) The intra-oral orthodontic remodeling device of claim 12, wherein said biocompatible covering comprises a medical grade silicone and said inner core comprises polycarbonate.

17) An improved orthodontic remodeling device having an extraoral housing containing a power source operably coupled to a 20-40 Hertz, 0.1-0.5 Newton vibrator operably coupled to a processor that controls said vibrator and records and transmits usage compliance data, said extraoral housing reversibly connected to a bite plate, the improvement comprising a bite plate that contacts occlusal surfaces of the incisors, cupids and premolars and contacts the facial surfaces of upper and lower incisors, but not the upper and lower premolars or molars.

18) A faster method of orthodontic remodeling, said method comprising a patient wearing a class II or III corrector biting the bite plate of the device of claim 1, and vibrating said device for about 20 minutes daily, wherein said method speeds orthodontic remodeling by 50% as compared to a comparable patient not using said device.

19) A faster method of orthodontic remodeling, said method comprising a patient wearing a class II or III corrector biting the bite plate of the device of claim 12, and vibrating said device for about 20 minutes daily, wherein said method speeds orthodontic remodeling by 50% as compared to a comparable patient not using said device.

20) A faster method of orthodontic remodeling, said method comprising a patient wearing a class II or III corrector biting the bite plate of the device of claim 17, and vibrating said device for about 20 minutes daily, wherein said method speeds orthodontic remodeling by 50% as compared to a patient using only said class II or III corrector.
